(19) United States
(12) Patent Application Publication
(10) Pub. No.: US 2025/0265748 A1
(43) Pub. Date: Aug. 21, 2025

(54) INFORMATION PROCESSING METHOD, INFORMATION PROCESSING APPARATUS, CONTROL SYSTEM, MANUFACTURING METHOD OF ARTICLE, AND STORAGE MEDIUM

(71) Applicant: CANON KABUSHIKI KAISHA, Tokyo (JP)

(72) Inventors: MASAFUMI YAMAMOTO, Tokyo (JP); AKIHIRO ODA, Kanagawa (JP); KEISUKE MURAKAWA, Kanagawa (JP)

(21) Appl. No.: 19/057,595

(22) Filed: Feb. 19, 2025

(30) Foreign Application Priority Data
Feb. 21, 2024 (JP) 2024-024992

(51) Int. Cl. G06T 11/20; B25J 13/06; G06T 11/00

(52) U.S. Cl. CPC G06T 11/206; B25J 13/06; G06T 11/001; G06T 2200/24

(57) ABSTRACT

An information processing method executed by a control portion configured to execute a plurality of processing units related to an operation of a control objective in a set sequence, the method includes receiving an operational input that specifies a starting position and an ending position for setting at least one processing unit as a subroutine among the plurality of processing units, and setting the subroutine based on the starting position and the ending position.

### BACKGROUND

### Field of the Disclosure

This disclosure relates to an information processing method, an information processing apparatus, a control system, a manufacturing method of an article, and a storage medium.

### Description of the Related Art

In information processing apparatuses that control operations of control objectives such as robots, for example, the control objectives are controlled by executing programs that process a plurality of processing units (hereinafter referred to as “modules”) in predetermined sequences. Then, in a case where the program is executed, for facilitating user comprehension, a flowchart illustrating a sequence in which the plurality of modules are executed is also displayed on a display apparatus (refer to U.S. Pat. No. 9,910,761 specification). The specification of this U.S. Pat. No. 9,910,761 is structured to visually and identifiably display an executed path, in which the program was executed, on the flowchart. As described above, the specification of U.S. Pat. No. 9,910,761 aims to improve the usability of an operation check (debug) by facilitating visual comprehension of which path in the flowchart was executed.

### SUMMARY

According to a first aspect of the present disclosure, an information processing method executed by a control portion configured to execute a plurality of processing units related to an operation of a control objective in a set sequence, the method includes receiving an operational input that specifies a starting position and an ending position for setting at least one processing unit as a subroutine among the plurality of processing units, and setting the subroutine based on the starting position and the ending position.

According to a second aspect of the present disclosure, an information processing apparatus includes a control portion configured to execute a plurality of processing units related to an operation of a control objective in a set sequence, wherein the control portion is configured to receive an operational input that, among the plurality of processing units, specifies a starting position and an ending position for setting a processing unit as a subroutine.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of an information processing apparatus according to one or more aspects of the present disclosure.

FIG. 2 is a flowchart illustrating a subroutinization procedure according to one or more aspects of the present disclosure.

FIG. 3 is a diagram illustrating a display screen of a flowchart according to one or more aspects of the present disclosure with a subroutine specified.

FIG. 4 is a diagram illustrating a display screen of the flowchart according to one or more aspects of the present disclosure with a subroutine containing a conditional branch specified.

FIG. 5 is a diagram illustrating a display screen of a flowchart configured to specify a subroutine according to one or more aspects of the present disclosure.

FIG. 6 is a diagram illustrating a display screen of a module list configured to specify a subroutine according to one or more aspects of the present disclosure.

FIG. 7 is a diagram illustrating a configuration of a robot system according to one or more aspects of the present disclosure.

FIG. 8 is a block diagram illustrating a configuration of a robot controller according to one or more aspects of the present disclosure.

FIG. 9 is a diagram illustrating a display screen according to one or more aspects of the present disclosure, containing a flowchart display section configured to specify a subroutine, a display section for displaying an execution result of the subroutine, and a display section for displaying parameter settings.

FIG. 10 is a diagram illustrating a case where a data reference source has been specified to change to “local” on the display screen in FIG. 9.

### DESCRIPTION OF THE EMBODIMENTS

However, in the specification of U.S. Pat. No. 9,910,761, even if it is possible to identify which path in the flowchart encountered a problem (e.g., an error), in a case of performing the operation check after correcting the problem in that path, execution will start from the first module in that path. Therefore, it is necessary to execute modules that are not related to parts requiring the operation check each time the operation check is performed, and further improvements in usability have been demanded.

Therefore, embodiments of this disclosure provide an information processing apparatus, an information processing method, a control system, a manufacturing method of an article, a program, and a recording medium that can improve the usability for the operation check.

### First Embodiment

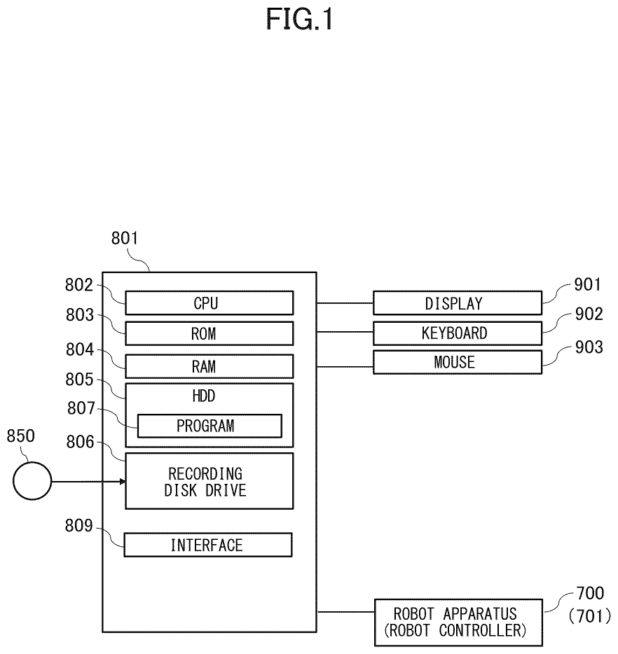

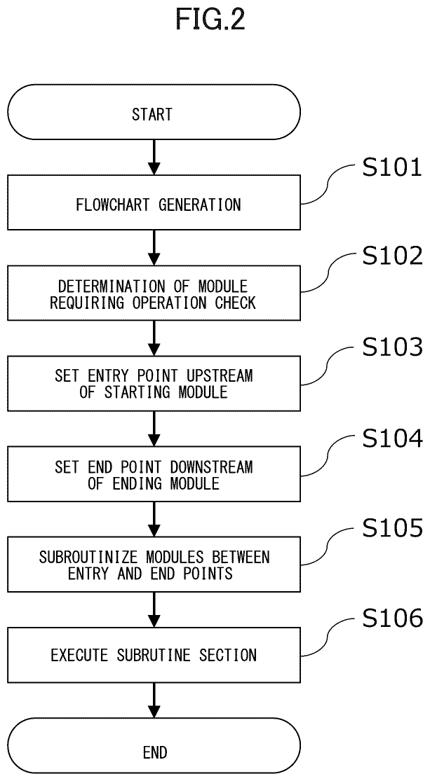

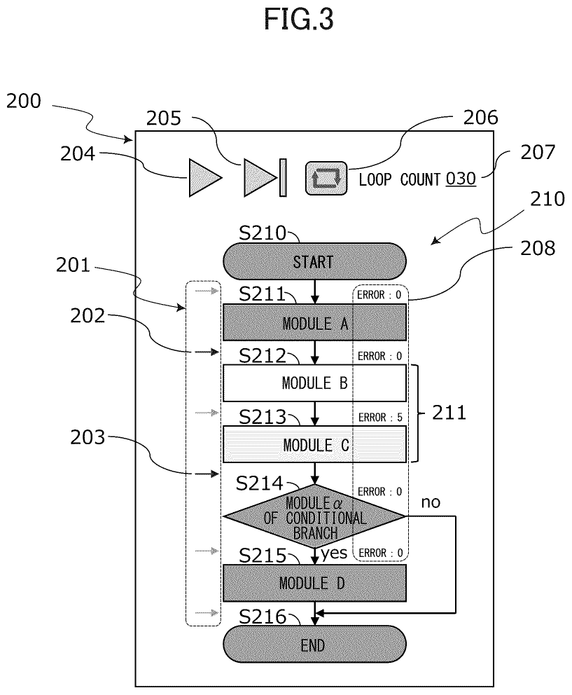

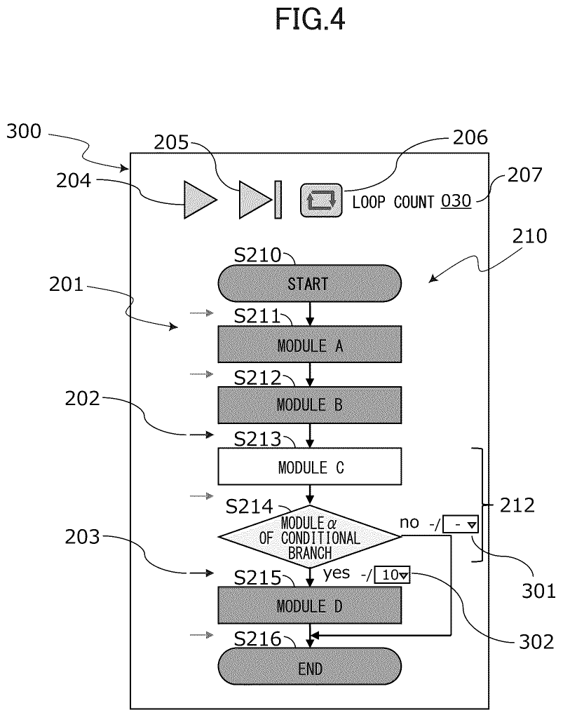

Hereinafter, using FIGS. 1 to 4, a first embodiment for implementing this disclosure will be described. FIG. 1 is a block diagram illustrating a configuration of an information processing apparatus according to the first embodiment. FIG. 2 is a flowchart illustrating a subroutinization procedure according to the first embodiment. FIG. 3 is a diagram illustrating a flowchart display screen configured to specify a subroutine according to the first embodiment. FIG. 4 is a diagram illustrating the flowchart display screen according to the first embodiment with a subroutine containing a conditional branch specified.

### Configuration of Information Processing Apparatus

First, using FIG. 1, the configuration of the information processing apparatus 801 according to this first embodiment will be described. As illustrated in FIG. 1, the information processing apparatus 801 includes a central processing unit (CPU) 802 that is an example of a processor. The CPU 802 is an example of a control portion. In addition, the information processing apparatus 801 includes a read only memory (ROM) 803, a random access memory (RAM) 804, and a hard disk drive (HDD) 805, each serving as a storage unit. Further, the information processing apparatus 801 includes a recording disk drive 806 and an interface 809 that is an example of an input/output unit. Then, through the interface 809, the information processing apparatus 801 is connected to a display 901, serving as a display apparatus that displays a display image as a display screen, and external equipment such as a keyboard 902 and a mouse 903, each serving as an input device that receives an operational input. In addition, through the interface 809, the information processing apparatus 801 is connected to, for example, a robot apparatus 100, serving as a control objective (or may be connected to, for example, a robot controller 701, described in a fourth embodiment). To be noted, the CPU 802, the ROM 803, the RAM 804, the HDD 505, the recording disk drive 806, and the interface 809 are connected by a bus to enable mutual information exchange among each other. In addition, through the interface 809, also the display 901, the keyboard 902, and the mouse 903 are connected to each device of the information processing apparatus 801 in a manner capable of communicating information.

Basic programs related to a computer operation are stored in the ROM 803. The RAM 804 is a storage device that temporarily stores various data, such as an arithmetic processing result of the CPU 802. On the HDD 805, the arithmetic processing result of the CPU 802, various externally obtained data, and the like are recorded, and a program 807 for executing various processing, described below, is recorded. The program 807 is application software where information on a plurality of processing units (hereinafter, referred to as “modules”), which the CPU 802 uses to execute processing related to an operation of the control objective, is described, and sequence information for executing these plurality of modules is configured. That is, by executing the program 807 recorded on the HDD 805, the CPU 802 performs the processing related to the operation of the control objective, in other words, such as the operation itself of the control objective and the arithmetic processing including the computation of a trajectory and positional posture for the operation and a calculation of a position and posture of a workpiece. In addition, the HDD 805 includes an area for recording information required when executing the subroutine, as described below. To be noted, the recording disk drive 806 can read various data, programs, and the like recorded on a recording disk 850. To be noted, the subroutine is sometimes simply referred to as “routine”. This subroutine setup enables the grouping of the processing units for repeated execution (batch execution). To be noted, a case of the batch execution includes a case where it is necessary to repeatedly execute at least one processing unit, and includes a case where a single processing unit is repeatedly executed.

To be noted, while, in this embodiment, a computer-readable non-transitory storage medium is the HDD 805, and the program 807 is recorded on the HDD 805, it is not limited to this. The program 807 may be recorded on any storage medium, as long as it is a computer-readable non-transitory storage medium. As a recording medium for supplying the program 807 to the computer, for example, a flexible disk, a hard disk, an optical disk, a magneto-optical disk, a magnetic tape, or a non-volatile memory can be used,

In addition, to the information processing apparatus 801, as described above, the robot apparatus 100, serving as the control objective, is connected. As described in detail below, the information processing apparatus 801 transmits a command signal to the robot apparatus 100 based on execution results obtained by executing the plurality of modules, and receives a signal from a sensor or a camera, serving as an image capturing device, of the robot apparatus 100. Thereby, the image processing apparatus 801 executes the processing related to the operation of the robot apparatus 100.

### Outline of Subroutinization Procedure

Next, using FIG. 2, an outline of a subroutinization procedure in a flowchart according to the first embodiment will be described. That is, in the first embodiment, the plurality of modules that perform the processing related to the operation of the robot apparatus 100 is generated as the flowchart based on a predetermined execution sequence, and the subroutine is created and executed in that flowchart. To be noted, the procedure illustrated in FIG. 2 shows a sequence of steps undertaken by the user (operator) when creating the subroutine.

As illustrated in FIG. 2, first, the user determines a sequence for the execution of the plurality of modules, and creates the flowchart by arranging those plurality of modules in that sequence (STEP S101). To be noted, this flowchart generation is performed, for example, by executing a flowchart creation application using the information processing apparatus 801 and by arranging the plurality of modules on the display screen of the display 901 in the execution sequence. Depending on the control objective (robots, cameras, machine tools, inspection equipment, etc.), this flowchart becomes a sequence of operations for initiating and completing one or a plurality of tasks (for example, assembly operations, adhesion operations, inspection operations, image capturing operations, transportation operations, disassembly operations, cutting operations, welding operations, etc.). That is, this created flowchart becomes an operation control program (hereinafter, simply referred to as “program 807”) that controls the operation of the control objective.

Next, the user determines the module requiring the operation check from the flowchart created on the display screen (STEP S102). To be noted, it is assumed that this module that requires the operation check is a plurality of consecutive modules, but it can also be a single module. Then, the user sets an entry point upstream of the module determined on the display screen (i.e., the module that requires the operation check to start). In other words, the user performs an operational input to select and specify a starting module (STEP S103). The entry point can also be referred to as a starting position that starts the subroutine. In addition, the user sets an end point downstream of the determined module (i.e., the module that requires the operation check to end). In other words, the user performs an operational input to select and specify an ending module (STEP S104). The end point can also be referred to as an ending position that ends the subroutine.

When the entry and end points are set in the flowchart as described above, the CPU 802 configures the modules between them as the subroutine. In other words, the CPU 802 performs a subroutinizing process on the selected modules (STEP S105). To be noted, this subroutinizing process may be performed in a case where the entry and end points are set, or, described in detail below, may be performed in a case where an operational input is performed on a play button 204 (refer to FIG. 3) displayed on the display screen for starting the operation check. Then, when the user activates the play button 204, the CPU 802 executes the modules between the entry and end points as the subroutinized process (STEP S106).

### Details of Subroutinization

Next, the details of the process to perform the subroutinization by specifying the subroutine from the flowchart according to the first embodiment will be described using a display screen 200 that displays the flowchart illustrated in FIG. 3, as an example.

As described above, the CPU 802 of the information processing apparatus 801 according to the first embodiment can create the program 807 that controls the robot apparatus 100 to perform a sequence of operations. That is, the CPU 802 of the information processing apparatus 801 creates and displays the display screen 200 on the display 901, serving as a graphical user interface (GUI). Then, on that display screen 200, the CPU 802 arranges the plurality of modules, which operate the robot apparatus 100, in a preferred sequence in accordance with the operational input of the user using such as the keyboard 902 and the mouse 903, and generates it as the flowchart. Thereby, the program 807 represented as the flowchart is developed.

As illustrated in FIG. 3, on the display screen 200 controlled by the CPU 802, for example, the user sequentially arranges modules A to C, a module a of a conditional branch, and a module D. Then, on the display screen 200, the CPU 802 displays the flowchart in a flowchart display section 210 with each module arranged in accordance with the specified sequence. To be noted, in the example illustrated in FIG. 3, processing to start the flowchart is arranged as STEP S210, the processing of the module A is arranged as STEP S211, and the processing of the module B is arranged as STEP S212. In addition, the processing of the module C is arranged as STEP S213, the processing of the module a of the conditional branch is arranged as STEP S214, the processing of the module D is arranged as STEP S215, and processing to end the flowchart is arranged as STEP S216.

Case where Subroutine Section 211 was Set

Next, when the flowchart is displayed in the flowchart display section 210, on the display screen 200, the CPU 802 displays an entry/end point display section 201, serving as a receiving setting section, arranged in parallel with the flowchart. In this entry/end point display section 201, a plurality of arrows (i.e., images indicating a plurality of selection positions) each indicating a space between modules with respect to all modules across the plurality of modules.

Here, for example, when, in the entry/end point display section 201, the user performs an operational input to select any one of the arrows described above as a first operational input, the CPU 802 sets the selected position as an entry point 202. In the example illustrated in FIG. 3, an arrow located upstream of the module B (STEP S212) is selected by the user, and the arrow is set as the entry point 202.

In addition, for example, when, in the entry/end point display section 201, the user performs an operational input to select any other one of the plurality of arrows described above as a second operational input, the CPU 802 sets the selected position as an end point 203. In the example illustrated in FIG. 3, an arrow located downstream of the module C (STEP S213) is selected by the user, and the position is set as the end point 203.

As described above, in the entry/end point display section 201, the user selects two points from the plurality of arrows described above (i.e., receiving step). Then, the one that is the earlier (upstream) in a sequence is set as the entry point 202, and the one that is the later (downstream) in the sequence is set as the end point 203. That is, the entry point 202 is a start location set among the modules, and the end point 203 is an end location set among the modules. When describing using the example in FIG. 3, a point resembling a start process (STEP S210) is arranged between the modules A and B, and a point resembling an end process (STEP S216) is arranged between the modules C and α.

When the entry and end points 202 and 203 are set as described above, the CPU sets the modules between these points as a subroutine section 211 (i.e., setting step). In other words, the modules between these points are subroutinized in a form detached from other modules in the execution sequence. To be noted, this subroutinization may be performed when the play button 204, described below, has been pressed. In this case, the subroutine section 211 merely indicates that the user has selected, and serves as a provisional selected range prior to performing the subroutinization.

To be noted, the subroutine can be defined as a standalone (single) flowchart with its own set start and end points. In addition, in the example of the display screen 200, the user performs the subroutinization to verify whether or not the operations of the modules B (STEP S212) and C (STEP S213) are performed as intended (designed purpose). Therefore, the user sets the entry point 202 upstream of the module B (STEP S212) and the end point 203 downstream of the module C (STEP S213).

When the subroutine section 211 was configured, on the display screen 200, the CPU 802 generates an image that enables the user to identify the subroutine section 211 with respect to other parts of the flowchart. In particular, the modules constituting the subroutine section 211, i.e., the modules B (STEP S212) and C (STEP S213) in the example illustrated in FIG. 3, have their display colors changed from the original. In other words, the subroutine section 211 is displayed in a color different from other parts. To be noted, in the example illustrated in FIG. 3, an example in which the CPU 802 displays the modules of the subroutine section 211 in white or light gray and displays modules other than the subroutine in the flowchart in dark gray is illustrated.

In addition, on the display screen 200, the CPU 802 generates and displays an image of the play button 204 that instructs a start of the execution of the subroutine section 211. For example, when the user presses the play button 204 on the display screen 200, the execution of the modules B (STET S212) and C (STEP S213) is started as the subroutine section 211. To be noted, when the user presses a button as an image displayed on the display screen, it refers to performing an operational input to select the image using a device such as the mouse or the keyboard. In addition, it is not limited to this, and, in a case where a display screen is displayed on an image display device such as, for example, a touch panel, an act of the user pressing a displayed button serves as an operational input.

In addition, on the display screen 200, the CPU 802 generates and displays an image of a step operation button 205 that instructs the execution of each module in the subroutine section 211 individually. For example, when the user presses the step operation button 205 on the display screen 200, first, only the module B (STEP S212) is executed, and, at this point, processing as the execution of the subroutine section 211 is paused. In the following description, the processing to pause the execution after executing one module is refers to as “step execution”. For example, when, as a next operation, the user presses the step operation button 205 on the display screen 200 again, the step execution is performed with respect to the module C (STEP S213). In addition, as described below, in a case where the subroutine section 211 is repeatedly executed for a loop count, when the user next presses the step operation button 205, the CPU 802 returns to the start of the subroutine section 211, and the step execution is performed on the module B (STEP S212). From here on, in the same manner, each time the step operation button is pressed, the step execution to execute only one module within the subroutine is performed. To be noted, when performing the step execution, the execution of which module is performed is visually indicated to the user by changing the display color of that mode. For example, on the display screen 200, the module to be executed next in the subroutine section 211 is displayed in white, and other modules in the subroutine section 211 are displayed in light gray.

In addition, on the display screen 200, the CPU 802 generates and displays an image of a repeat button 206 that instructs the repeated execution of the processing of the subroutine section 211. In addition, on the display screen 200, the CPU generates and displays an image of a loop count display section 207, serving as a set count display section, to input and set the loop count as the number of times for repeatedly executing the processing of the subroutine section 211. For example, when, by entering a numerical value in the loop count display section 207 on the display screen 200, the user sets the loop count for the execution of the subroutine section 211 and, thereafter, presses the repeat button 206, the CPU 802 repeats the execution of the subroutine section 211 for the set loop count.

Then, on the display screen 200, the CPU 802 displays an error count display section 208 indicating the number of errors that have occurred in each module when repeatedly executing the processing of the subroutine section 211. For example, assume that the user presses the repeat button 206 on the display screen 200 and the execution of the subroutine section 211 is repeated for the loop count set in the loop count display section 207. In this case, if an error occurs in each module (when the module fails to complete the processing correctly), the number of occurrences is counted, and the number of errors is displayed in a form linked to an area adjacent to that module. In the example of FIG. 3, it is indicated that, in a case where the subroutine section 211 has been repeatedly executed 30 times, five errors occurred in the module C. As described above, by displaying the occurrence of the error during the execution of each module using the error count display section 208, it is possible to display an error occurrence position in the subroutine section 211 and the number of error occurrences. As described above, by visualizing the module which is susceptible to errors, it is possible to improve usability during the modification of the flow chart by the user.

Case where Subroutine Section 212 was Set

Next, a case where, for example, the user has selected and set a subroutine section 212 containing the conditional branch will be described using FIG. 4. As illustrated in FIG. 4, on a display screen 300, for example, the arrow located upstream of the module C (STEP S213) and the arrow located downstream of the module a (STEP S214) are selected by the user. Then, as with the above description, the entry and end points 202 and 203 are set. Thereby, by the CPU 802, the subroutine section 212 containing the conditional branch is set.

For example, in a flowchart of the display screen 300, in response to an execution result (output information) of the module C (STEP S213), the determination of the conditional branch at the module a (STEP S214) of the conditional branch changes. Therefore, by setting the entry and end points 202 and 203 to include the module a of the conditional branch, only by executing the subroutine section 212, it is possible to perform the operation check to ensure that the conditional branch at the module a is changing appropriately.

Corresponding to branch destinations of the module a of the conditional branch, the CPU 802 generates and displays images of upper limit setting sections 301 and 302 on the display screen 300.

The user can set an upper limit count for each of these upper limit setting sections 301 and 302. That is, assume that the user pressed the repeat button 206 described above and the subroutine section 212 has been repeatedly executed. In this case, even if an iteration has not reached the count set in the loop count display section 207, when the iteration has reached the upper limit count of the upper limit setting section 301 or 302, the execution of the subroutine section 212 ends.

For example, on the display screen 300 illustrated in FIG. 4, 10 iterations are set to the upper limit setting section 302, and the upper limit count is not set to the upper limit setting section 301. In addition, 30 iterations are set to the loop count display section 207 as the loop count. When the user presses the repeat button 206 under this condition, the execution of the subroutine section 211 is repeated. Then, based on the execution result (i.e., determination result) of the module C (STEP S213), the number of occurrences is counted (tallied) for each determination of “yes” and “no” in the module a of the conditional branch. To be noted, this counted number of occurrences is displayed alongside each of the upper limit setting sections 301 and 302, but, since the display screen 300 illustrated in FIG. 4 indicates a state before the execution of the subroutine section 212, “-” is displayed. In addition, in such as a case where the conditional branch module a illustrated in FIG. 4 results in “no”, in a case where the upper limit count is not set in the upper limit setting section 302, it is not necessary to count the determination count. Therefore, if the upper limit count is set in at least one of the plurality of the upper limit setting sections, the CPU 802 counts at least one determination count of the determination results.

Then, in a case where the execution of the subroutine section 212 is repeated and, before the execution of the subroutine section 212 reaches 30 iterations, the subroutine section 212 reaches “10” occurrences where the module a of the conditional branch results in “yes”, the subroutine section 212 ends at that time. That is, the upper limit setting sections 301 and 302 possess a function that ends the repeated execution of the subroutine section 212 in a case where an output of a specific determination result reaches the set upper limit count. To be noted, also in a case where the execution of the subroutine section 212 has reached “30” iterations before a case where the module a of the conditional branch results in “yes” has reached “10” occurrences, the execution of the subroutine section 212 ends based on that condition.

The settings of the upper limit count as described above can be used, for example, in a case of confirming how many times “no” occurs while obtaining “yes” 10 times at the conditional branch module. To describe an example, it is conceivable that an image of a workpiece is captured using the camera in the module B, image recognition and the like are performed in the module C, and an operation is executed using the robot apparatus 100 at the module D based on the successful identification of the workpiece. At this time, for example, the occurrence of “no” in the module a of the conditional branch indicates that the recognition of the workpiece has failed, and it is preferred that “no” occurs as little as possible within 10 occurrences of “yes”. In this operation check of the subroutine section 212, it is conceivable, for example, to adjust a parameter (for example, such as an edge detection parameter or exposure time) at the module C or B based on the number of occurrences of “no” within the 10 occurrences of “yes”.

To be noted, in this embodiment, for example, in a case where the end point set downstream of the module is avoided by the conditional branch, it is configured such that the processing is executed until the end of the flowchart. In particular, for example, in the flowchart of the display screen 300, the end point is set downstream of the module D (STEP S215), and, in a case where the execution result of the module a (STEP S214) of the conditional branch is “no”, the processing is executed until the end of the flowchart. However, it is not limited to this, and it is acceptable that, in a case where the execution result of the module a (STEP S214) of the conditional branch is “yes”, the execution of the subroutine section 212 ends by execution the module D, and, in a case where the execution result of the module a (STEP S214) of the conditional branch is “no”, the execution of the subroutine section 212 ends without subsequent processing.

### Summary of First Embodiment

As described above, in the information processing apparatus 801 according to the first embodiment, the CPU 802 receives the input where, for example, the user arranges each module in the execution sequence as the flowchart. Then, the plurality of modules, each describing the processing related to the operation of the robot apparatus 100, becomes executable in the set sequence. Here, the CPU 802 receives the operational input that specifies the starting module among the plurality of modules (for example, in FIG. 3, the module B) and the ending module (for example, in FIG. 3, the module C).

In addition, the CPU 802 can execute the subroutine section based on, for example, the operational input of the play button 204 by the user.

In addition, the information processing apparatus 801 includes the interface 809. Information related to the receipt of the operational input is input from the device such as the keyboard 902 and the mouse 903 to the interface 809, and information on the display image related to the display screen on such as the display 901 is output by the interface 809. Thereby, it is possible to receive the operational input of the user and display the display image related to the execution result, so that it is possible to achieve functionality as the GUI.

In addition, the CPU 802 generates the display screen that displays the plurality of modules, and displays it using such as the display 901. Then, on the display screen, the CPU 802 receives the setting operation of the entry point as the first operational input to specify the starting module and the setting operation of the end point as the second operational input to specify the ending module. Thereby, the user can visually and easily select and set the subroutine section from the display screen.

In addition, on the display screen (for example, the display screen 200 in the FIG. 3), the CPU 802 generates the flowchart display section 210 displaying the flowchart in which the plurality of modules are arranged in the set sequence. Thereby, the user can visually and easily recognize the presence of the plurality of modules and their execution sequence.

In addition, in the flowchart display section 210, the CPU 802 generates the image in which the subroutine section (for example, the subroutine section 211 in FIG. 3) is identifiable. Thereby, in a case where the user sets the entry and end points, it is possible to visually and easily recognize which modules are set as the subroutine section.

In addition, in the flowchart display section 210, in a case where the CPU 802 receives the entry and end points, the CPU 802 changes the display color of the image corresponding to the plurality of modules from the starting module to the ending module. Thereby, on the display screen, it is possible to display the subroutine section in a manner identifiable by the user.

In addition, in the flowchart display section 210, the CPU 802 generates the entry/end point display section 201 that is arranged in parallel with the flowchart and displays the image of the specified position (for example, the arrow in FIG. 3) of the entry point in the case of receiving the entry point. Thereby, the user can visually and easily recognize the entry point.

In addition, in the flowchart display section 210, the CPU 802 generates the entry/end point display portion 201 that is arranged in parallel with the flowchart and displays the image of the position (for example, the arrow in FIG. 3) in which, in a case of having received the end point, the end point is specified. Thereby, the user can visually and easily recognize the end point. To be noted, while, in this embodiment, both the entry and end points are displayed in the entry/end point display section 201, it is acceptable to display these in separate sections.

In addition, the CPU 802 can repeatedly execute the subroutine section until it reaches the set loop count, which is the loop count set in the loop count display section 207 by the user. Thereby, a desired loop count for executing the operation check in the subroutine section can be easily set.

In addition, on the display screen, the CPU 802 generates the image of the loop count display section 207 displaying the loop count, and receives the operational input for setting the loop count. Thereby, the user can set the loop count while visually recognizing it.

In addition, the CPU 802 counts at least one determination count of the determination result in a case where, in the subroutine section 212, the module containing the conditional branch that branches to proceed to the next sequence according to the determination result (for example, the module a in FIG. 4) is included. Then, the CPU 802 repeatedly executes the subroutine until that determination count reaches the upper limit count. Thereby, it is possible to perform the operation check of the module based on a state in which the upper limit count is reached.

In addition, on the display screen, the CPU 802 generates the image of the upper limit setting section 302, serving as the upper limit count display section that displays the upper limit count, and receives the operational input for setting the upper limit count. Thereby, the user can set the upper limit count while visually recognizing it.

In addition, in a case of having repeatedly executed the subroutine section, the CPU 802 determines errors in each module of the subroutine section, and counts the number of error occurrences. Then, the CPU 802 generates the image of the error count display section 208 that displays the number of respective error occurrences in a position corresponding to each module on the display screen (for example, the display screen 200 in FIG. 3). Thereby, the user can visually and easily recognize which module encountered the error and how many times it occurred.

In addition, on the display screen, the CPU 802 generates the image of the play button 204, serving as a start instruction display section that instructs an execution start of the subroutine section, and, when an operation to press that play button 204 is detected, receives the operational input for instructing the execution start. Thereby, the user can instruct the execution start of the subroutine section while visually recognizing it.

In addition, on the display screen (for example, the display screen 200 in FIG. 3), the CPU 802 generates the image of the step operation button 205 that instructs to pause each time a module of the subroutine section is executed. Then, by detecting the operation in which the step operation button 205 is pressed, the CPU 802 receives the operational input for instructing to pause each time the module is executed. Thereby, the user can perform the operation check by executing each module one at a time.

To be noted, in this embodiment, the method of selecting arrow symbols in the entry/end point display section 201 is described. However, it is not limited to this, and, for example, it could be in a format where a display section allows for the arbitrary drag-and-drop of pin-type icons, or a color of a clicked module inverts to specify the subroutine section.

### Second Embodiment

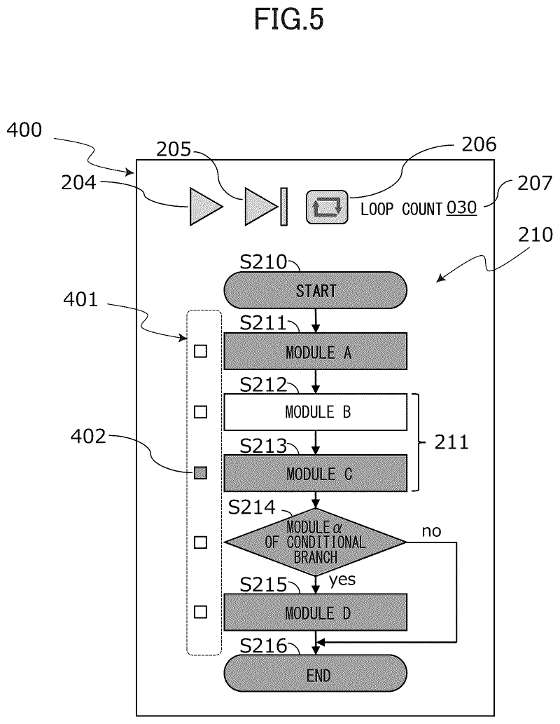

Next, using FIG. 5, a second embodiment in which the first embodiment is partly modified will be described. FIG. 5 is a diagram illustrating a display screen of a flowchart configured to specify the subroutine according to the second embodiment. To be noted, in the description of this second embodiment, the same reference characters are used for parts that are similar to those in the first embodiment, and their description will be omitted.

In the first embodiment described above, the entry and end points 202 and 203 are set between the modules to establish the subroutine sections 211 and 212. In contrast, in this second embodiment, by setting a breakpoint with respect to the module and by setting the starting module, the subroutine section 211 is established.

In detail, as illustrated in FIG. 5, on a display screen 400 that the CPU 802 controls, an image of a breakpoint display section 401, serving as a receiving setting section, is generated and displayed in parallel with the flowchart display section 210. In the breakpoint display section 401, checkboxes are displayed adjacent to each module in a lateral direction, and the user can set a breakpoint 402 by selecting any checkbox.

For example, in the display screen 400 in FIG. 5, when the user selects the checkbox adjacent to the module C (STEP S213), the breakpoint 402 (i.e., ending position) is set at the module C. To be noted, the breakpoint 402 is essentially set at the end of the processing at the module C. In other words, when executing the subroutine section 211, the processing is continued until the processing as the module C is completed. In other words, it becomes a state that resembles having the end point set downstream of the module C. In addition, for example, on the display screen 400 in FIG. 5, when the user selects a box itself of the module B (STEP S212), the module B is set as the starting module (i.e., starting position) of the subroutine section 211. In other words, it becomes a state that resembles having the entry point set upstream of the module B. Thereby, the subroutine section 211 from the module B to the module C is established. Therefore, as with the first embodiment, by pressing the play button 204 in this state, the subroutine section 211 is executed (repeatedly executed), and it is possible to perform the operation check of the subroutine section 211.

To be noted, in a case where only the checkbox of the module C is selected, the module C may serve as the starting and ending positions of the subroutine. In addition, by configuring the checkboxes of the modules B and C to be selectable, in a case where these two boxes are selected, it is acceptable that the module B serves as the starting position of the subroutine and the module C serves as the ending position of the subroutine.

In addition, as illustrated in FIG. 5, the established subroutine section 211 is displayed in a manner identifiable to the user by a display color of the module B, in which the entry point is set, and the display of the checkbox of the breakpoint 402. For example, on the display screen 400, a background color of the module B that is selected as the entry point is changed to white, and background colors of unselected modules are displayed in gray.

### Summary of Second Embodiment

Also in the information processing apparatus 801 according to the second embodiment described above, the CPU 802 receives the operational input for setting the starting module (for example, in FIG. 5, the module B) and the ending module (for example, in FIG. 5, the module C) from the plurality of modules. In other words, the starting module is specified by directly selecting the module, and the ending module is specified by selecting the breakpoint 402. Thereby, a range from the starting module to the ending module is configured as the subroutine section (for example, in FIG. 5, the subroutine section 211). Therefore, since the subroutine section that executes only the modules requiring the operation check is configured, the modules that are unrelated to the parts requiring the operation check are not executed each time the operation check is performed, it is possible to improve usability for the operation check.

To be noted, since the configuration, the functionality, and an impact of the second embodiment, aside from those described above, are identical to the first embodiment described above, their description will be omitted.

### Third Embodiment

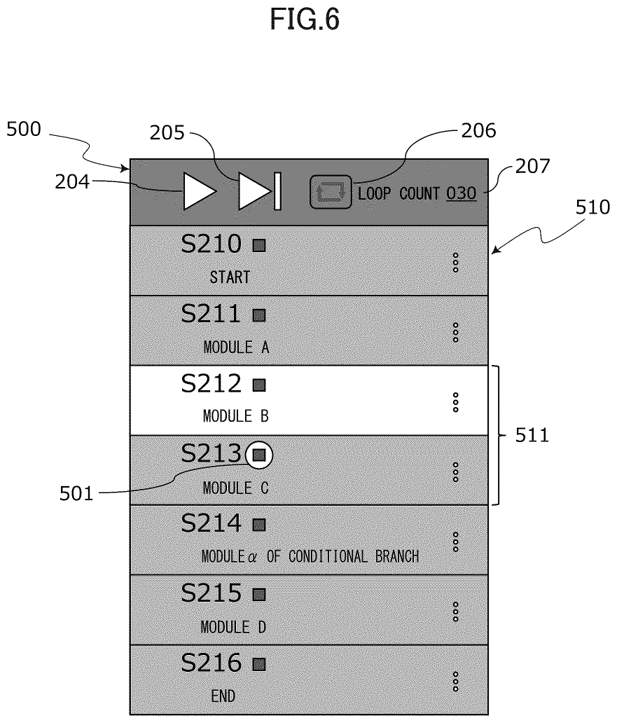

Next, using FIG. 6, a third embodiment in which the first and second embodiments are partly modified will be described. FIG. 6 is a diagram illustrating a display screen of a flowchart configured to specify the subroutine according to the third embodiment. To be noted, in the description of this third embodiment, the same reference characters are used for parts that are similar to those in the first and second embodiments, and their description will be omitted.

In the first and second embodiments described above, on the display screens 200, 300, and 400, each module is generated in a flowchart format and displayed in the flowchart display section 210. In contrast, in this third embodiment, on a display screen 500, the CPU 802 generates and displays an image of a list display section 510 in which each module is generated and displayed in a list format.

In detail, each module is listed and displayed in the list display section 510, and a checkbox image is generated and displayed for each module. The plurality of modules displayed as the list are essentially arranged in the execution sequence from top to bottom.

To be noted, in the list of each module illustrated in FIG. 6, when the user presses an ellipsis on a right side of a column for each module, information regarding the execution sequence of that module is displayed to enable the visual recognition of the execution sequence. Especially, at the module a of the conditional branch, by pressing the ellipsis, it is displayed that the processing proceeds to the module D in a case of “yes” and proceeds to the end in a case of “no”.

Then, images of selectable checkboxes which the user can arbitrarily select are displayed to each of the plurality of listed modules described above. For example, when the user selects any checkbox, the breakpoint is set to the module linked to that checkbox, and an area adjacent to that checkbox is generated and displayed as an image of a breakpoint display section 501.

For example, on the display screen 500 in FIG. 6, when the user selects the checkbox of the module C (STEP S213), the breakpoint display section 501 is set at the module C. To be noted, the breakpoint display section 501 is essentially set to the end of the processing at the module C. In other words, when executing a subroutine section 511, the execution continues until the processing as the module C is completed. In other words, it becomes a state that resembles having the end point (i.e., ending position) set downstream of the module C. In addition, for example, on the display screen 500 in FIG. 6, when the user selects the list itself of the module B (STEP S212), the module B is set as the module where the subroutine section 511 is started. In other words, it becomes a state that resembles having the entry point (i.e., starting position) set upstream of the module B. Thereby, the subroutine section 511 from the module B to the module Cis established. Therefore, as with the first and second embodiments, by pressing the play button 204 in this state, the subroutine section 511 is executed (repeatedly executed), and it is possible to perform the operation check of the subroutine section 511.

In addition, as illustrated in FIG. 6, the subroutine section 511 that has been established is displayed in a manner identifiable to the user by the display color of the module B, in which the entry point is set, and the display of the breakpoint display section 501. For example, on the display screen 500, the background color of the module B that is selected as the entry point is changed to white, and background colors of the unselected modules are displayed in gray.

### Summary of Third Embodiment

Also in the information processing apparatus 801 according to the third embodiment described above, the CPU 802 receives the operational input to set the starting module (for example, in FIG. 6, the module B) and the ending module (for example, in FIG. 6, the module C) from the plurality of modules. In other words, the starting module is specified by directly selecting the module, and the ending module is specified by selecting the breakpoint display section 501. Thereby, a range from the starting module to the ending module is configured as the subroutine section (for example, in FIG. 6, the subroutine section 511). Therefore, since the subroutine section that executes only the modules requiring the operation check is configured, the modules that are unrelated to the parts requiring the operation check are not executed each time the operation check is performed, and it is possible to improve the usability for the operation check.

In addition, on the display screen (for example, the display screen 500 in FIG. 6), the CPU 802 generates the list display section 510 that displays the plurality of modules as the list. Thereby, the user can visually and easily recognize the presence of the plurality of modules and their execution sequence.

In addition, in the list display section 510, the CPU 802 generates the image that enables the identification of the subroutine section 511. Thereby, in a case where the user has set the starting and ending modules, the user can visually and easily recognize which modules have been set as the subroutine section.

In addition, in the list display section 510, in a case where the operation for selecting the module is received as the first operational input, the CPU 802 changes the display color of the image corresponding to the module that starts the subroutine section. Thereby, on the display screen, it is possible to display the module that starts the subroutine section as an identifiable image.

In addition, in the list display section 510, in a case where the operation for selecting the breakpoint is received as the second operational input, the CPU 802 displays the image, which indicates the receipt of the breakpoint selection, on the image corresponding to the module that ends the subroutine section. Thereby, on the display screen, it is possible to display the module that ends the subroutine section as an identifiable image.

To be noted, since the configuration, the functionality, and an impact of the third embodiment, aside from those described above, are identical to the first embodiment described above, their description will be omitted.

### Fourth Embodiment

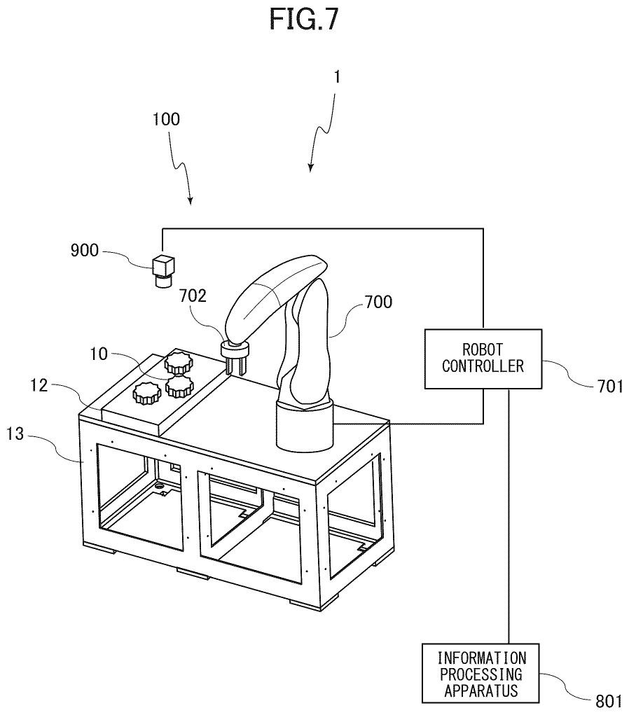

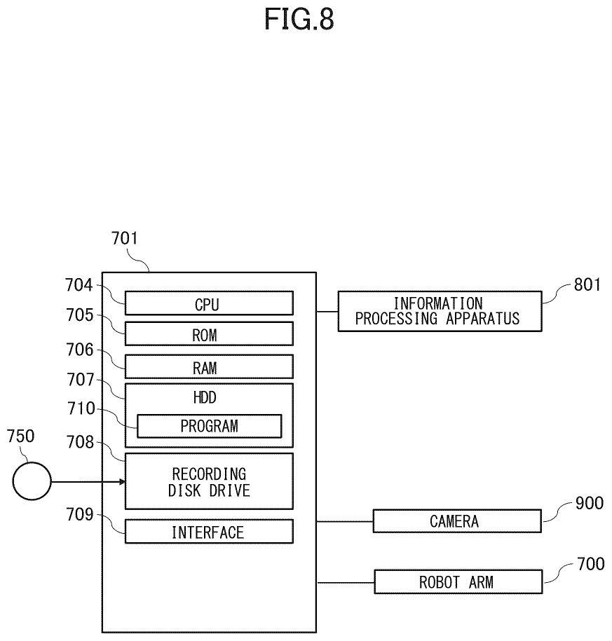

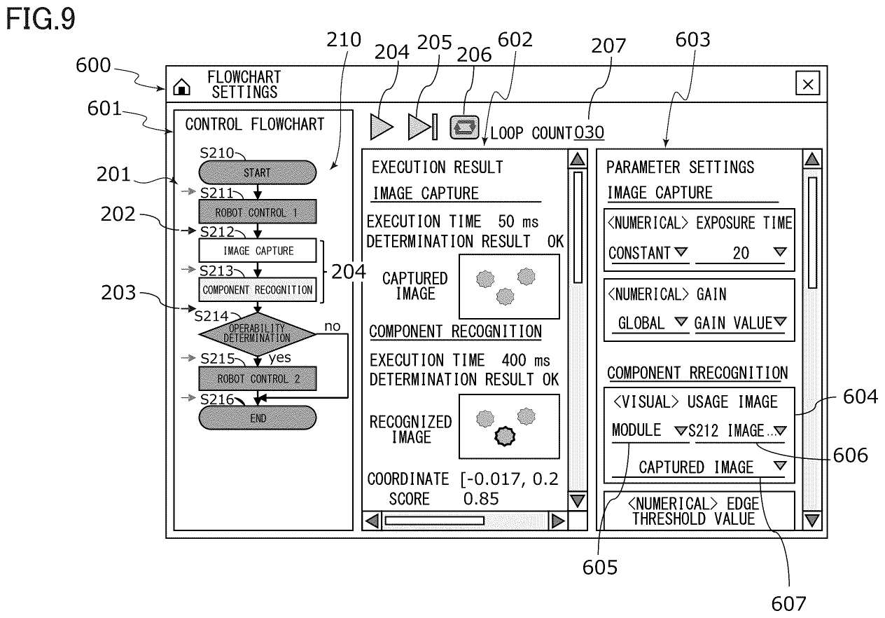

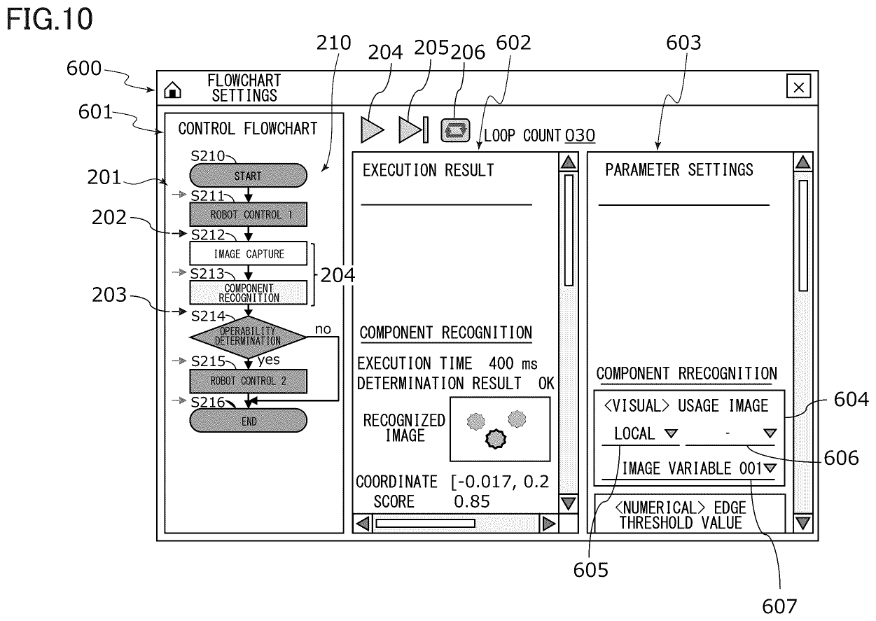

Next, using FIGS. 7 to 10, a fourth embodiment in which the first embodiment is partly modified will be described. FIG. 7 is a diagram illustrating a configuration of a robot system according to the fourth embodiment. FIG. 8 is a block diagram illustrating a configuration of a robot controller according to the fourth embodiment. FIG. 9 is a diagram illustrating a display screen including a display section of a flowchart configured to specify a subroutine, a display section of an execution result of the subroutine, and a display section for setting a parameter. FIG. 10 is a diagram illustrating a case where a data reference source has been specified to change to “local” on the display screen in FIG. 9. To be noted, in the description of this fourth embodiment, the same reference characters are used for parts that are similar to those in the first embodiment, and their description will be omitted.

In this fourth embodiment, the operation check of the robot apparatus 100, serving as the control objective, is performed by the information processing apparatus 801 according to the first embodiment described above. In particular, the flowchart described in the first embodiment controls the robot apparatus 100 to grip and transfer a component 10 by recognizing a workpiece through image recognition, and the subroutine section performs the operation check of part of such an operation. To be noted, the information processing apparatus 801 will be described below as being integrated into the robot system 1, serving as a control system, in conjunction with the robot apparatus 100.

### Schematic Configuration of Robot System

First, using FIG. 7, a schematic configuration of the robot system according to the fourth embodiment will be described. As illustrated in FIG. 7, the robot system 1, for example, is an assembly system that automatically grips and conveys the component 10, serving as an assembly workpiece, and mounts it onto a workpiece, not shown. The robot system 1 primarily includes the robot apparatus 100, serving as the control objective, a camera 900, serving as the control objective or an image capturing device, and the information processing apparatus 801. In addition, the robot apparatus 100 includes a robot arm (manipulator) 700 that is fixedly supported on a stand 13 and serves as a robot, and a robot controller 701 that controls the robot arm 700.

In addition, the robot apparatus 100 includes a robot hand 702 that is an end effector attached to an end of the robot arm 700 and serves to grip (hold) the component 10. As long as the robot hand 702 can hold the component 10, there are no specific restrictions in a shape or structure, and, for example, a configuration that uses suction to grip the component 10 is acceptable. In addition, the robot hand 702 may include a force sensor or the like as necessary.

In addition, the component 10 is placed on a component placement platform 12 installed on the stand 13, and the robot system 1 includes the camera 900, serving as the control objective, located above the component placement platform 12, in other words, located above the component 10. The camera 900 captures images of an imaging region (capture range) including at least the component 10, and acquires them as image data. This camera 900 may be a two dimensional camera having a capability of outputting two dimensional image data, or a three dimensional camera, such as a stereo camera, having a capability of outputting three dimensional image data. To be noted, while, in this embodiment, the camera 900 is a fixed camera which is installed, for example, on a factory ceiling or the like, any camera, including an on-hand camera mounted on the robot hand 702, that can acquire the images of the imaging region including the component 10 is acceptable. The image data captured by the camera 900 is sent to the robot controller 701, and the information is processed as described in detail below. Here, the information processing refers to the calculation of command values for robot control (e.g., robot arm trajectory and the like) by the robot controller 701 for the purpose of assembling a component 10 to the component 11.

To be noted, the robot system 1 configured as described above performs the assembly operation to assemble the component 10, which is gripped by the robot hand 702 of the robot apparatus 100, to a workpiece, not shown. As described above, the robot system 1 performs the assembly operation to assemble the component 10 with respect to a workpiece using the robot apparatus 100, and, thereby, manufactures a workpiece with the component 10 assembled as an article. In other words, the robot system 1 performs a manufacturing method to manufacture the article with the component 10 assembled using the robot apparatus 100.

### Configuration of Robot Controller

Next, using FIG. 8, a configuration of the robot controller 701 will be described. As illustrated in FIG. 8, the robot controller 701 includes a CPU 704 that is an example of a processor. The CPU 704 is an example of a control portion. In addition, the robot controller 701 includes a ROM 705, a RAM 706, and an HDD 707, each serving as a storage unit. In addition, the robot controller 701 includes a recording disk drive 708 and an interface 709, serving as an input/output interface. The CPU 704, the ROM 705, the RAM 706, the HDD 707, the recording disk drive 708, and the interface 709 are interconnected via a bus to enable mutual communication.

In the ROM 705, basic programs related to an operation of a computer are stored. The RAM 706 is a storage device for temporarily storing various data such as an arithmetic processing result of the CPU 704. On the HDD 707, the arithmetic processing result of the CPU 704 and various data acquired externally are recorded, and a program 710 that instructs the CPU 704 to execute various processing related to the operation processing of the robot apparatus 100 is also recorded. The program 710 is application software that allows the CPU 704 to execute various processing. Therefore, the CPU 704 can control the operation of the robot hand 700 by performing control processing through the execution of the program 710 recorded on the HDD 707. The recording disk drive 708 can read various data, programs, and the like recorded on a recording disk 750.

To be noted, while, in this embodiment, a computer-readable non-transitory recording medium is the HDD 707, and the program 710 is stored on the HDD 707, it is not limited to this. The program 710 may be recorded on any recording medium, as long as it is a computer-readable non-transitory recording medium. As a recording medium for supplying the program 710 to a computer, for example, a flexible disk, a hard disk, an optical disk, a magneto-optical disk, a magnetic tape, a non-volatile memory, and the like can be used.

In addition, the camera 900, the robot arm 700, and the information processing apparatus 801 described above are connected to the robot controller 701. As described in detail below, to the robot controller 701, information related to the operation processing of the robot apparatus 100 (operation instructions for the robot arm 700 and the camera 900) is sent from the information processing apparatus 801. In addition, the camera 900 sends the captured image data to the robot controller 701, and the image data is processed by the program 710. The processing result is sent to the information processing apparatus 801.

To be noted, in this fourth embodiment, the arithmetic processing for the operation of the robot apparatus 100 (robot arm 700, camera 900, and the like) is performed by the information processing apparatus 801 (CPU 802). Then, based on the information of the arithmetic processing result sent from the information processing apparatus 801, the robot controller 701 (CPU 704) actually performs the operation control of the robot arm 700 and the camera 900. However, it is not limited to this, these tasks may be performed by one computer, i.e., using a single CPU, or may be performed by equal to or more than three computers, i.e., using equal to or more than three CPUs.

### Configuration of Display Screen

Next, using FIG. 9, a display screen 600 which is generated by the CPU 802 and is displayed on the display 901 will be described. As illustrated in FIG. 9, the display screen 600 is configured to primarily include a control content display section 601, an execution result display section 602, and a parameter setting display section 603. The control content display section 601 includes the flowchart display section 210 that displays the flowchart (hereinafter, referred to as a control flowchart) controlling the robot apparatus 100, and the entry/end point display section 201. The user can generate the control flowchart by performing an operation to arrange each module in the flowchart display section 210. In addition, a result for each module in a case of having executed the control flowchart is displayed in the execution result display section 602. Then, in the parameter setting display section 603, various parameters used in each module of the control flowchart are displayed, and the user can set the various parameters by selecting or inputting a numerical value. To be noted, in this parameter setting display section 603, the various parameters used in each module of the control flowchart can be set by performing a collective operational input.

### Outline of Control Flowchart

Next, a case where, for example, in the information processing apparatus 801, the user generates the control flowchart related to a gripping operation of the component 10 by the robot apparatus 100 will be described as an example. As illustrated in FIG. 9, the user arranges, for example, the plurality of modules in an execution sequence as illustrated in FIG. 9, and generates the flowchart that controls the robot apparatus 100. Hereinafter, a case of executing the entire flowchart will be described, and a case of establishing and executing a subroutine section will be described later.

In this flowchart, “start” (STEP S210) is a processing module for starting the control. “Robot control 1” (STEP S211) is a processing module for performing an operation to move the robot arm 700 to an initial position for gripping the component 10 with the robot arm 700. To be noted, the component 10 may be set on the component placement platform 12 by, for example, a robot arm of a robot apparatus adjacent to the robot apparatus 100, or may be manually set by an operator.

“Image capture” (STEP S212) is a processing module for capturing an image of the component 10 located on the component placement platform 12. The CPU 802 executes the “image capture” (STEP S212) while controlling the camera 900 using the parameters set in the parameter setting display section 603. As the execution result of this “image capture” (STEP S212), information such as an image and a numerical value captured by the camera 900 are displayed in the execution result display section 602.

“Component recognition” (STEP S213) is a processing module for performing an image analysis using the image captured at “image capture” (STEP S212). That is, “component recognition” is a processing module that recognizes a position and posture of the component 10 to be gripped by detecting an edge of the component 10 captured in the image and matching it with a model image. The CPU 802 executes “component recognition” (STEP S213) using the parameters set in the parameter setting display section 603. As the execution result of this “component recognition” (STEP S213), information such as the image, in which the edge of the component 10 has been detected, and the numerical value is displayed in the execution result display section 602.

“Operability determination” (STEP S214) is a processing module in which whether or not an operation to grip the recognized component with the robot hand 702 of the robot arm 700 is possible is determined. In a case where it is determined that the component recognized at “component recognition” (STEP S213) can be gripped, the CPU 802 marks this as “yes”, and proceeds to “robot control 2” (STEP S215). On the other hand, in a case where it is determined that the component 10 cannot be gripped due to such as a case where the component 10 could not be recognized during “component recognition” (STEP S213), the CPU 802 marks this as “no”, and straightly proceeds to “end” (STEP S216) to end the execution of the flowchart.

“Robot control 2” (STEP S215) is a processing module that controls the operation of the robot hand 702 to grip the component 10 in a case where, at “operability determination” (STEP S214), it is determined that the component 10 can be gripped. Based on the information on the position (coordinate) and posture of the component 10 recognized at “component recognition” (STEP S213), by controlling the robot arm 700 and the robot hand 702, the CPU 802 executes the operation to grip the recognized component 10 located on the component placement platform 12 with the robot hand 702. Then, when the gripping operation of the component 10 ends, the CPU 802 proceeds to “end” (STEP S216), and ends the execution of the control flowchart. To be noted, while, in this control flowchart, the flowchart up to gripping the component 10 is described, thereafter, by executing other flowcharts, the assembly operation is performed by executing operations to assemble the component to a workpiece, not shown.

### Establishment and Execution of Subroutine Section

Next, the establishment of the subroutine section 211 to only partly perform the operation check of the control flowchart described above and its execution will be described. Since the establishment and the execution of this subroutine section 211 are similar to the first embodiment, a description will be provided simply.

When the user performs the operational input to select the entry and end points 202 and 203 in the entry/end point display section 201, the CPU 802 establishes the modules between them as the subroutine section 211. In the example illustrated in FIG. 9, two modules of “image capture” (STEP S212) and “component recognition” (STEP S213) are established as the subroutine section 211. Then, when the user performs the operational input by pressing the play button 204, the CPU 802 repeatedly executes the subroutine section 211 for the set loop count.

When the subroutine section 211 is executed, in the execution result display section 602, the CPU 802 collectively displays the execution results of all subroutinized modules in a visual and numerical format. In the example illustrated in FIG. 9, in the execution result display section 602, as the execution result of “image capture” (STEP S212), the execution results such as an execution time, a determination result, and a captured image are displayed. In addition, in the execution result display section 602, as the execution result of “component recognition” (STEP S213), the execution results such as an execution time, a determination result, a recognized image, a coordinate of the component 10, and a score as recognition success metrics are displayed.

In addition, parameters used in each module of the subroutine section 211 are displayed in a list in the parameter setting display section 603, and they can be edited collectively. Further, after the execution of the subroutine section 211, by selecting a corresponding module in the parameter setting display section 603, it is possible to display only the results and the parameters of the selected module.

In the example illustrated in FIG. 9, as the parameters used at “image capture” (STEP S212), an exposure time and a value of a gain are displayed in a configurable manner in the parameter setting display section 603. In addition, as the parameter used at “component recognition” (STEP S213), an image that is used (hereinafter, referred to as a “usage image”) and a threshold value of the edge are displayed in a configurable manner in the parameter setting display section 603.

Incidentally, to perform the operation check by executing the subroutine section 211, even if only the modules of the subroutine section 211 require the operation check, data acquired in the modules upstream of the subroutine section 211 in the flowchart is needed. For example, on the display screen 600 illustrated in FIG. 9, when executing “component recognition” (STEP S213), the usage image which is the execution result of the preceding “image capture” (STEP S212) is needed. Therefore, even in a case of intending to skip executing “image capture” (STEP S212) and set the subroutine section 211 to start from the “component recognition” (STEP S213) for performing the operation check, it is still required to input the usage image.

Therefore, the usage image is specified in a usage image setting section 604 in the parameter setting section 603, and, thereby, the execution of “component recognition” (STEP S213) is enabled. For example, in the example illustrated in FIG. 9, in the usage image setting section 604 in the parameter setting section 603, the user can specify how the data is referenced. First, the user selects a data reference method in a parameter selection method section 605.

As options, for example, there are three methods: “module”, “local”, and “global”. In a case where the user has selected “module”, for example, the data of the execution result acquired from “image capture” (STEP S212) during the previous execution of the flowchart is referenced, and is used at “component recognition” (STEP S213). To be noted, in the case of selecting “module”, processing involves, after creating the control flowchart, executing once the control flowchart from the beginning during the initial run, and storing the execution results of each module at that time on the storage unit such as the HDD 805. In addition, in a case where the user has selected “local”, the data on which the user previously performed the operational input for storing on the storage unit such as the HDD 805 of the information apparatus 801 is referenced, and is used solely for “component recognition” (STEP S213) of the current flow chart. Then, in a case where the user has selected “global”, the data stored on the storage unit such as the HDD 805 of the information apparatus 801 is referenced, and, can also be used commonly for modules of other flowcharts, in addition to “component recognition” (STEP S213) of the current flow chart.

In the example illustrated in FIG. 9, it is illustrated that the user has selected “module”, and, in a reference module setting section 606, has selected to reference the execution result of the module of “image capture” (STEP S212). Then, it is illustrated that, in a data selection section 607, the data of “usage image” is referenced from the execution results of “image capture” (STEP S212).

On the other hand, in a case where the user specifies the data by selecting “local” or “global”, a display in the usage image setting section 604 is changed as illustrated in FIG. 10. FIG. 10 illustrates a state in which “local” is selected in the parameter selection method setting section 605. At this time, in the data setting section 607, a reference image variable is specified to, for example, “image variable 001”, and this indicates that the data of “image variable 001”, which, in the information processing apparatus 801, the user has previously performed the operation input for storing in the storage unit, is referenced. As described above, by using the previously stored data present within the information processing apparatus 801, it is possible to perform “component recognition” (STEP S213) without executing “image capture” (STEP S212).

To be noted, the settings for the reference data source described above are not limited to the parameter for “component recognition” (STEP S213). In other words, the reference data is not limited to the image data, and various numerical values and conditional branches and their results can also be set in the same manner.

In addition, in the fourth embodiment described above, the display screen 600 is described as an example to subroutinize the control flowchart that controls the operation of the robot apparatus 100. However, the control objective that the information processing apparatus 801 controls is not limited to the robot apparatus 100, and any interface is acceptable as long as it includes a screen with functionalities or processing for executing by subroutinizing the operation check of the control objective.

### Summary of Fourth Embodiment

Also in the information processing apparatus 801 according to the fourth embodiment described above, the CPU 802 receives the operational input to specify the starting module (e.g., in FIG. 9, “image capture”) and the ending module (e.g., in FIG. 9, “image recognition”) from the plurality of modules. Thereby, the range from the starting module to the ending module is established as the subroutine section (e.g., in FIG. 9, the subroutine section 211). Therefore, since the subroutine section executing only the modules that require the operation check is configured, the modules that are unrelated to the modules requiring the operation check are not executed each time the operation check is performed, and it is possible to improve the usability for the operation check.

In addition, in a case of executing the subroutine section, the CPU 802 executes the subroutine section (e.g., “component recognition”) using the information (e.g., usage image) of the execution results of the modules (e.g., “image capture”), which are aside from the subroutine and have been executed before the execution of the subroutine section, as the parameters. Thereby, it is possible to eliminate the need to execute modules (e.g., “image capture”) other than those included in the subroutine section each time the subroutine section (e.g., “component recognition”) is executed, and it becomes possible to execute only the subroutine section.

In addition, in a case of executing the subroutine, the CPU 802 executes the subroutine section using information stored in the storage unit as the parameter. Also, by this means, it becomes possible to eliminate the need to execute the modules (e.g., “image capture”) other than those included in the subroutine section each time the subroutine section (e.g., “component recognition”) is executed, and it becomes possible to execute only the subroutine section.

In addition, on the display screen 600, the CPU 802 generates the execution result display section 602 that displays the execution result of the subroutine section. Thereby, the user can visually perform the operation check of the robot apparatus 100 by visually assessing the execution result of the subroutine section.

In addition, in a case where a module describing the execution of the image analysis, such as, for example, “component recognition” is included in the subroutine section, the CPU 802 displays the execution result of the image analysis in the execution result display section 602. Thereby, the user can confirm how the image analysis has been performed, and can also confirm the reliability of the image analysis.

### Possibilities of Other Embodiments

In the first to fourth embodiments described above, the robot apparatus 100 is operated as the control objective, and the partial operation check of the robot apparatus 100 is performed by the subroutine section. However, the control objective is not limited to the robot apparatus, and any type of apparatus is acceptable.

In addition, in the first to fourth embodiment described above, in a case where the subroutine section is configured in the flowchart or the list, the entry and end points are set, or the breakpoint is set. However, it is not limited to this, and any system that enables configuring modules to start and end the subroutine is acceptable, regardless of its form. In addition, the starting and ending modules can be the same.

In addition, the display screens 200, 300, 400, and 600 described in the first to fourth embodiments are examples, and any display format is acceptable. For example, while the color of the module is changed to make the subroutinized part in the flowchart identifiable, altering brightness or activating the light is acceptable. Further, hiding or removing the module other than the subroutine is acceptable. In addition, the images of such as the play button 204, the step operation button 205, the repeat button 206, and the loop count display section 207 are examples, and can be in any form. Further, the layout and display formats of the control content display section 601, the execution result display section 602, and the parameter setting display section 603 can be in any configuration.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-024992, filed Feb. 21, 2024, which is hereby incorporated by reference herein in its entirety.

What is claimed is:

1. An information processing method executed by a control portion configured to execute a plurality of processing units related to an operation of a control objective in a set sequence, the method comprising:
receiving an operational input that specifies a starting position and an ending position for setting at least one processing unit as a subroutine among the plurality of processing units; and
setting the subroutine based on the starting position and the ending position.

2. The information processing method according to claim 1, further comprising:
executing the subroutine.

3. The information processing method according to claim 2, further comprising:
generating a display image that displays the plurality of processing units and displaying on a display apparatus,
wherein the control portion is configured to receive, in the display image, a first operational input that specifies the starting position, and a second operational input that specifies the ending position.

4. The information processing method according to claim 3, wherein, in the display image, the control portion generates a flowchart display section that displays a flowchart in which the plurality of processing units are arranged in the set sequence.

5. The information processing method according to claim 4, wherein, in the flowchart display section, the control portion generates an image in which the subroutine is identifiable.

6. The information processing method according to claim 5, wherein, in the flowchart display section, in a case of having received the first operational input and the second operational input, the control portion changes a display color of an image corresponding to a plurality of processing units within a range from the starting position to the ending position.

7. The information processing method according to claim 4, wherein, in the flowchart display section, the control portion generates a receiving setting section that is arranged in parallel with the flowchart and, in a case of having received the first operational input, displays an image that indicates a position specified by the first operational input.

8. The information processing method according to claim 4, wherein, in the flowchart display section, the control portion generates a receiving setting section that is arranged in parallel with the flowchart and, in a case of having received the second operational input, displays an image that indicates a position specified by the second operational input.

9. The information processing method according to claim 3, wherein, in the display image, the control portion generates a list display section that displays at least two processing units as a list.

10. The information processing method according to claim 9, wherein, in the list display section, the control portion generates an image that enables identification of the subroutine.

11. The information processing method according to claim 9, wherein, in the list display section, in a case of having received the first operational input, the control portion changes a display color of an image that corresponds to the starting position.

12. The information processing method according to claim 9, wherein, in the list display section, in a case of having received the second operational input, the control portion displays an image that indicates receipt of the second operational input.

13. The information processing method according to claim 2, wherein the control portion repeatedly executes the subroutine until a set count is reached.

14. The information processing method according to claim 13, further comprising:
generating a display image that displays at least two processing units and displaying the display image on a display apparatus,
wherein, in the display image, the control portion generates a set count display section that displays the set count, and receives an operational input for setting the set count.

15. The information processing method according to claim 14, wherein, in a case where the subroutine includes a processing unit in which a conditional branch to proceed to a next sequence in accordance with a determination result is described, the control portion counts at least one determination count, and repeatedly executes the subroutine until the determination count reaches an upper limit count.

16. The information processing method according to claim 15, wherein, in the display image, the control portion generates an upper limit count display section that displays the upper limit count, and receives an operational input for setting the upper limit count.

17. The information processing method according to claim 14, further comprising:
displaying, in a case of having repeatedly executed the subroutine, a count of error occurrences in each processing unit in the subroutine in a position that corresponds to each processing unit in the display image, by determining errors in each processing unit and counting the count of error occurrences.

18. The information processing method according to claim 14, wherein, in the display image, the control portion generates a start instruction display section that instructs an execution start of the subroutine, and receives an operational input that instructs the execution start.

19. The information processing method according to claim 18, wherein, in the display image, the control portion generates a pause display section that instructs to pause execution of the subroutine each time the processing unit of the subroutine is executed, and receives an operational input that instructs to pause the execution of the subroutine each time the processing unit is executed.

20. The information processing method according to claim 2, wherein, in a case of executing the subroutine using a parameter, the control portion executes the subroutine using information on an result of executing a processing unit not included in the subroutine prior to executing the subroutine as the parameter.

21. The information processing method according to claim 2, wherein, in a case of executing the subroutine using a parameter, the control portion executes the subroutine using information stored in a storage unit as the parameter.

22. The information processing method according to claim 2, further comprising:
generating a display image that displays the plurality of processing unit and displaying the display image on a display apparatus,
wherein the control portion displays, in the display image, an execution result that is obtained by executing the subroutine.

23. The information processing method according to claim 22, wherein, in a case where the subroutine includes a processing unit in which processing to execute an image analysis is described, when displaying the execution result, the control portion displays the execution result of the image analysis.

24. An information processing apparatus comprising:
a control portion configured to execute a plurality of processing units related to an operation of a control objective in a set sequence,
wherein the control portion is configured to receive an operational input that, among the plurality of processing units, specifies a starting position and an ending position for setting a processing unit as a subroutine.

25. A control system comprising:
the information processing apparatus according to claim 24; and
a control objective whose operation is controlled according to processing described in each of the plurality of processing units.

26. The control system according to claim 25, wherein the control objective includes a robot apparatus.

27. The control system according to claim 25, wherein the control objective includes an image capturing apparatus.

28. A manufacturing method of an article comprising:
manufacturing the article using the control system according to claim 25.

29. A non-transitory computer-readable storage medium that stores instructions configured to allow a computer to execute the information processing method according to claim 1.
